(19) United States
(12) Patent Application Publication
(10) Pub. No.: US 2025/0005741 A1
(43) Pub. Date: Jan. 2, 2025

(54) INSPECTION DEVICE CONFIGURED TO PROVIDE ENHANCED INSPECTION OF FIBER COLOR ORDER IN RIBBONIZED FIBER OPTIC CABLE

(71) Applicant: BELDEN CANADA ULC, SAINT-LAURENT (CA)

(72) Inventor: Tahereh Ahmadi TAMEH, Kirkland (CA)

(73) Assignee: BELDEN CANADA ULC, SAINT-LAURENT (CA)

(21) Appl. No.: 18/756,642

(22) Filed: Jun. 27, 2024

Related U.S. Application Data
(60) Provisional application No. 63/523,558, filed on Jun. 27, 2023.

(51) Int. Cl. G06T 7/00; G06F 3/04842; G06T 7/73; G06T 7/90

(52) U.S. Cl. CPC G06T 7/001; G06F 3/04842; G06T 7/73; G06T 7/90; G06T 2207/10024; G06T 2207/20092; G06T 2207/30164

(57) ABSTRACT

An inspection device may include an illumination portion configured to illuminate a fiber optic ribbon cable to be inspected, an imaging portion configured to image an illuminated fiber optic ribbon cable to be inspected, and a controller configured to inspect a fiber optic ribbon cable. The controller may be configured to control the imaging portion to generate an image of the fiber optic ribbon cable being inspected, to generate first image values from the image of the inspected fiber optic ribbon cable, and to compare the first image values with stored second image values of a selected fiber optic ribbon cable comprising colored fibers arranged in a selected color order. The controller may be configured to determine whether the fibers of the inspected fiber optic ribbon cable are arranged in a same color order as the fibers of the selected fiber optic ribbon cable so as to enhance accuracy of determining that the fibers of the inspected fiber optic ribbon cable are in a correct order before termination of the inspected fiber optic ribbon cable with a connector.

### CROSS REFERENCE TO RELATED APPLICATION

This application claims the benefit of U.S. Provisional Application No. 63/523,558, filed Jun. 27, 2023, the disclosure of which is hereby incorporated by reference herein in its entirety.

### TECHNICAL FIELD

The present disclosure generally relates to a device for detecting a color order of colored wires in a cable. More particularly, the device is configured to confirm the accuracy of an arrangement of colored fibers in a multi fiber cable.

### BACKGROUND

In some types of optical cables, the cables may include a plurality of individual fibers. Such cables may include optical-fibers, for example. The fibers may be configured to be optically separate from each other such that each fiber may be configured to carry its own optical signal. Each of the fibers within such a cable may be configured with a color such that the color may be used to distinguish each of the fibers from each other. For example, each of the fibers may have a colored outer coating or jacket.

In some implementations, portions of such optical-fiber cables may be ribbonized with the colored optical fibers arranged in a predesignated or particular order. Additionally, a plurality of types of such ribbonized optical-fiber cables may be assembled, where some of the types of optical-fiber cables may be assembled with a different order of colors of the optical-fibers. During the assembly of such optical-fiber cables, according to conventional processes, the order of the colors of the optical-fibers may be judged by human inspection and judgment. This may lead to errors in not detecting an improperly assembled cable having an incorrect order of the colors of the optical-fibers. Detecting such errors in the order of the colors of the fibers of the ribbonized cables may be difficult because of the small size of ribbonized portion of the optical-fibers in one or both of a length and a diameter of the optical-fibers.

It may therefore be desirable to provide an inspection device that is configured to detect whether the fibers are assembled in the ribbonized cable with a proper order of the colors of the fibers so as to avoid human error in such inspection. It may be desirable to provide a device that is configured to confirm the accuracy of an arrangement of colored fibers in a multi fiber cable before termination of the inspected fiber optic ribbon cable with a connector.

### SUMMARY

According to various exemplary embodiments of the disclosure, an inspection may include an illumination portion configured to illuminate a fiber optic ribbon cable to be inspected, an imaging portion configured to image an illuminated fiber optic ribbon cable to be inspected, a memory portion configured to store an RGB color map for each of a plurality of known fiber optic ribbon cable, an input portion configured to permit a user to select one of the known fiber optic ribbon cables; and a controller configured to inspect a fiber optic ribbon cable. The controller may be configured to control the imaging portion to generate an image of a fiber optic ribbon cable being inspected, to generate an RGB color map of colored fibers from the image of the inspected fiber optic ribbon cable, and to compare the RGB color map from the image with the stored RGB color map. The controller may be configured to determine whether the fibers of the inspected fiber optic ribbon cable are arranged in a same color order as the fibers of the selected known fiber optic ribbon cable so as to enhance accuracy of determining that the fibers of the inspected fiber optic ribbon cable are in a correct order before termination of the inspected fiber optic ribbon cable with a connector.

According to various exemplary embodiments of the disclosure, an inspection device may include an illumination portion configured to illuminate a fiber optic ribbon cable to be inspected, an imaging portion configured to image an illuminated fiber optic ribbon cable to be inspected, a memory portion configured to store image values for a selected fiber optic cable, wherein each of the selected fiber optic cables comprises fibers arranged in a known color order, and a controller configured to inspect a fiber optic ribbon cable. The controller may be configured to control the imaging portion to generate an image of the fiber optic ribbon cable being inspected, to generate image values from the image of the inspected fiber optic ribbon cable, and to compare the generated image values with the image values of the stored image values of the selected fiber optic ribbon cable. The controller may be configured to determine whether the fibers of the inspected fiber optic ribbon cable are arranged in a same color order as the fibers of the selected fiber optic ribbon cable so as to enhance accuracy of determining that the fibers of the inspected fiber optic ribbon cable are in a correct order before termination of the inspected fiber optic ribbon cable with a connector.

According to various exemplary embodiments of the disclosure, an inspection device may include an illumination portion configured to illuminate a fiber optic ribbon cable to be inspected, an imaging portion configured to image an illuminated fiber optic ribbon cable to be inspected, and a controller configured to inspect a fiber optic ribbon cable. The controller may be configured to control the imaging portion to generate an image of the fiber optic ribbon cable being inspected, to generate first image values from the image of the inspected fiber optic ribbon cable, and to compare the first image values with stored second image values of a selected fiber optic ribbon cable comprising colored fibers arranged in a selected color order. The controller may be configured to determine whether the fibers of the inspected fiber optic ribbon cable are arranged in a same color order as the fibers of the selected fiber optic ribbon cable so as to enhance accuracy of determining that the fibers of the inspected fiber optic ribbon cable are in a correct order before termination of the inspected fiber optic ribbon cable with a connector.

### BRIEF DESCRIPTION OF THE DRAWINGS

Further advantages and features of the present disclosure will become apparent from the following detailed description and the accompanying drawings.

FIG. 1 illustrates ribbonized fiber-optic cables in accordance with various aspects of the disclosure.

FIG. 2 illustrates an inspection device in accordance with various aspects of the disclosure.

FIG. 3 illustrates generation of a color map in accordance with various aspects of the disclosure.

### DETAILED DESCRIPTION

Reference will now be made in detail to presently preferred embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure. Furthermore, the terminology used herein is used only for the purpose of describing particular embodiments of the present disclosure and is not intended to be limiting in any way.

As used in the specification and the appended claims, the singular form “a,” “an,” and “the” include plural referents unless the context clearly indicates otherwise. For example, reference to a component in the singular is intended to also include a plurality of components.

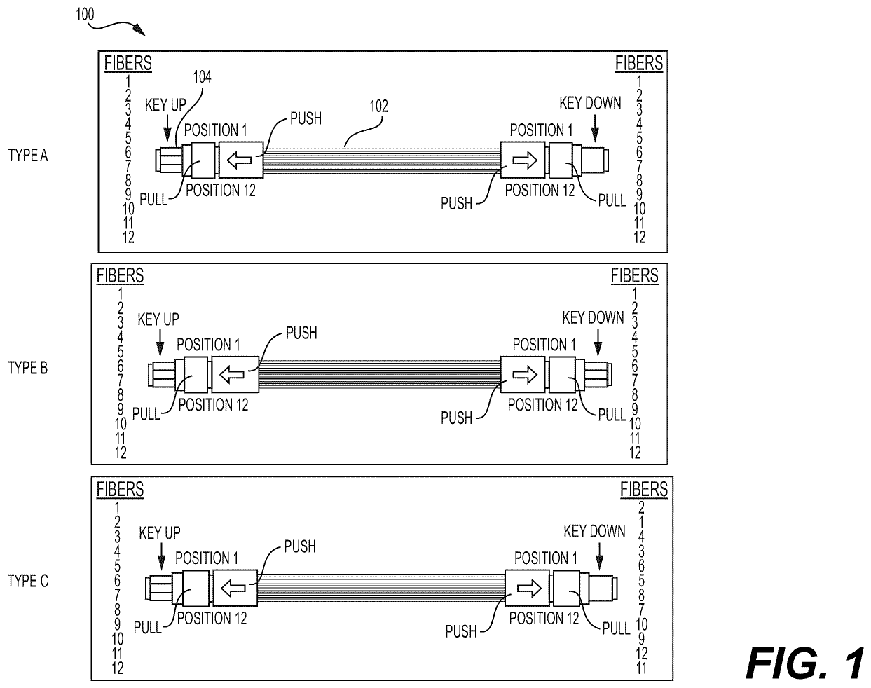

FIG. 1 illustrates exemplary fiber-optic cables 100 that may be used in accordance with various aspects of the disclosure. The fiber-optic cables 100 include a plurality of colored fibers 102 that have been ribbonized. In the illustrated embodiment, three different types of ribbonized fiber-optic cables 100 are illustrated. The three types of ribbonized fiber-optic cables 100 are designated as Type A, Type B and Type C. Each of the three types of ribbonized fiber-optic cables may be different from each other, as further explained herein. However, any number of different types of fiber-optic cables may be used in conjunction with the aspects disclosed herein.

The Type A, Type B, and Type C ribbonized fiber-optic cables illustrated in FIG. 1 may be different from each other in several ways, such as a different ordering of the colors of the fibers 102, a different keying, etc. For example, a first type of cable may have an ordering from 1 to 12 of blue, orange, green, brown, grey, white, red, black, yellow, purple, pink, and light blue, while other types of cables may have a different ordering. When the cables are assembled or thereafter, the order of the colors needs to be verified by inspection to ensure the cable has been assembled properly.

In the examples of the Type A, Type B, and Type C ribbonized fiber-optic cables illustrated in FIG. 1, the keying is different as shown by keys 104. The Type A cable has keying indicating that fiber 1 goes to fiber 1, etc. The Type B cable has keying indicating that fiber 1 goes to fiber 12, etc. The Type C cable has keying indicating that each pair of fibers 102 are crossed. Any combination of ordering of the colors of the fibers 102 may be detected and verified by various embodiments disclosed herein

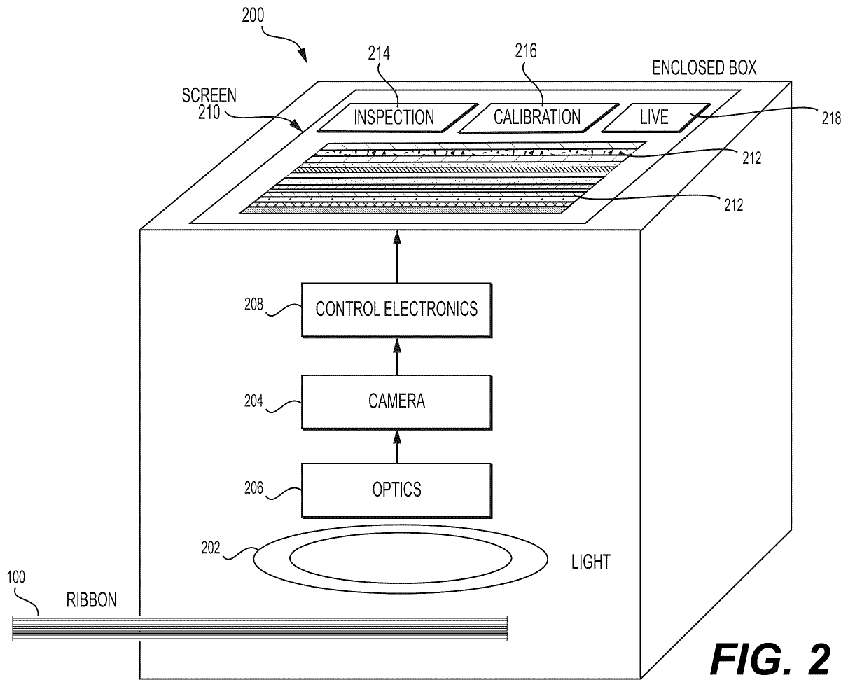

FIG. 2 illustrates the inspection device 200 in accordance with various embodiments. The Inspection device 200 may be configured to inspect/detect an order of the colors of the optical fibers in a cable, such as a ribbonized optical fiber cable 100. However, in some embodiments, the inspection device may be configured to detect an order of colored wires/fibers in other types of cables.

The inspection device 200 may include a light or illumination portion 202 to illuminate the cable to be inspected, a camera or imaging portion 204 including optics 206 to image the cable 100, and control electronics 208 for controlling the inspection device 200. In some embodiments, the inspection device 200 may also include a screen or user interface 210. The screen or user interface 210 may be configured to display an image or images 212 of cables captured by the camera 204.

In some embodiments, the camera 204 may be a CCD (charge-coupled device).

In some embodiments, the inspection device 200 may also include selectable elements or an input portion such as an inspection selectable element 214 and a calibration selectable element 216 to cause the inspection device 200 to perform an inspection and/or a calibration. The selectable elements may be any type of selectable elements such as a pushbutton, a selectable element on a screen such as selectable by a mouse, a selectable element on a touchscreen, etc. In some embodiments, the inspection device may include a Live selectable element 218. The Live selectable element 218 when selected is configured to cause an image of the current ribbonized cable to be displayed, whether a reference ribbonized cable or the ribbonized cable 100 under test.

In some embodiments, the inspection device 200 may be enclosed in a box 220 or other enclosure. In some embodiments, one or more portions of the control electronics 208 could be located outside of the box 220.

In some embodiments, the control electronics 208 may include a processor, a memory and software stored in the memory (not shown) to carry out the functionality of the inspection device 200 described herein. In some embodiments, the inspection device 200 may be configured to be controlled by an application run on an external device, such as a computer, a phone, a tablet, etc. In some embodiments, the camera 204 may be stationary or movable. The inspection device 200 may also include an area such as below the light 202 and camera 204 to place a ribbonized fiber-optic cable 102 to be inspected or for calibration. In some embodiments, the enclosure may include an opening to insert the cable 102.

In some embodiments, the inspection device 200 may be configured to perform a calibration before an inspection is run. In some embodiments, the calibration may be performed by first placing a ribbonized cable that is known to have the colors of the fibers in a correct order for the type of cable to be inspected in an area where the imaging by the camera 204 occurs with illumination by the light 202 under control of the control electronics 208. In some embodiments, the inspection device 200 may be configured to perform the calibration when the calibration selectable 216 element is selected by a user.

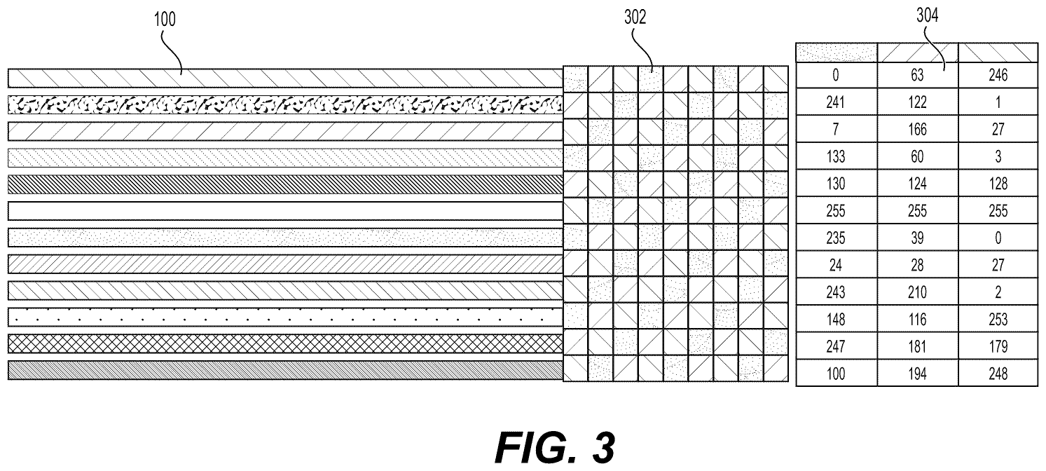

The control electronics 208 may the cause the camera 204 to generate an image of the ribbonized cable that is known to have the colors of the fibers in a correct order. The image is then analyzed by the processor and software to prepare a color map of the known cable. As shown in FIG. 3, for example, the cable 100 is imaged by pixels 302 to create the color map 304. The color map includes RGB values for each of the fibers. The color map may then be stored in the memory and is associated with a particular type of cable. When that type of cable is to be inspected such as by selection of the inspection selectable element, the inspection device 200 is configured to cause the camera 204 to create an image of the cable to be inspected, generate RGB values for each colored fiber in the cable, and compare the newly generated RGB values to the RGB values previous generated for the known cable.

If the RGB values match, the cable may be determined by the inspection device 200 to have passed the inspection and have a correct order of the colored fibers. If the RGB values do not match, the cable may be determined by the inspection device 200 to have not passed the inspection and have an incorrect order of the colored fibers. In some embodiments, the inspection device 200 may output a result of the inspection, such as an indicator of the result, a report, etc. The result could indicate for example that certain fiber colors of the cable have been incorrectly swapped.

In some embodiments, the inspection device 200 may apply may be configured to apply a certain amount of acceptable variability to the RGB values when doing the comparison of stored RGB values to RGB values of a cable undergoing inspection to take into account small variations in particular colors of the fibers that may be present, as well as other variations that may occur when the cable is imaged. For example, +/− values may be determined.

In some embodiments, the memory of the control electronics 208 may have stored therein colormaps with RGB values of various known cables having various orders of the ribbonized cables. The memory may also store images of the known cables. In some embodiments, when the inspection selectable element 214 is selected by a user, the inspection device 200 may enter an inspection routine. The inspection routine may allow the user to select between various types of inspection. The types of inspection may include one where a known cable is imaged, the RGB values of the known cable are determined as first RGB values, a cable to be inspected is imaged, the RGB values of the cable are determined as second RGB values, and the first and second RGB values are compared to determine a match in the RGB values.

In another type of inspection, the memory may store RGB values of various cables with different color orders of the optical fibers, along with images of the cables. In various embodiments, when the inspection selectable element is selected by a user, the user may be presented with the various stored cables on the display 210, and the user may be able to select one of the stored cables to be used in the inspection. In some embodiments, the display 210 may display images of the respective cables and allow the user to select one of the stored cables to be used. After the user selects one of the cables, the corresponding RGB values stored in the memory are used to compare with RGB values of the cable being inspected.

In some embodiments, the inspection device 200 may calibrate the light 202 to provide a consistent color and intensity of light to each measurement. Additionally, the inspection device 200 may image the cable to determine that the cable is at a particular angle (such as 90 degrees) to an imaging axis of the camera to provide consistent imaging results. This may involve converting an image of the cable to greyscale and determining from the greyscale conversion whether the cable is correctly positioned with a rotation angle. The inspection device 200 may be configured to provide the user with instructions to reposition the cable when needed during such a calibration.

In some embodiments, the inspection device 200 may be configured to cause the image of the cable to crop out any background portions of the image so that the RGB values can be efficiently determined.

Embodiments of the invention may be configured to work with any number of colored fibers arranged next to each other. For example, there may be two fibers, twelve fibers or any other number of fibers greater than one. Additionally, the inspection device may be configured to function with types of cables other than ribbonized fiber-optic cables, such as a cable that have individual colorized elements that need to be arranged in a particular order. Embodiments are not limited to optical-fiber cables but can work with any cable with colored ribbonized elements. Embodiments are capable of working with any fiber or cable size such as 160 μm/200 μm/250 μm/900 μm, etc.

While multiple non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An inspection device configured to provide enhanced inspection of a color order of colored fibers in a fiber optic ribbon cable, comprising:
an illumination portion configured to illuminate a fiber optic ribbon cable to be inspected;
an imaging portion configured to image an illuminated fiber optic ribbon cable to be inspected;
a memory portion configured to store an RGB color map for each of a plurality of known fiber optic ribbon cable;
a input portion configured to permit a user to select one of the known fiber optic ribbon cables;
a controller configured to inspect a fiber optic ribbon cable; wherein the controller is configured to control the imaging portion to generate an image of a fiber optic ribbon cable being inspected;
wherein the controller is configured to generate an RGB color map of colored fibers from the image of the inspected fiber optic ribbon cable;
wherein the controller is configured to compare the RGB color map from the image with the stored RGB color map; and
wherein the controller is configured to determine whether the fibers of the inspected fiber optic ribbon cable are arranged in a same color order as the fibers of the selected known fiber optic ribbon cable so as to enhance accuracy of determining that the fibers of the inspected fiber optic ribbon cable are in a correct order before termination of the inspected fiber optic ribbon cable with a connector.

2. The inspection device of claim 1, wherein the inspection device is configured to output an indication of whether the fiber optic ribbon cable being inspected has a same fiber color order as the selected fiber optic ribbon cable.

3. The inspection device of claim 1, wherein the controller is configured to perform a calibration by causing the imaging portion to create a calibration image of a fiber optic ribbon cable, creating an RGB color map of the image, and comparing the RGB color map of the calibration image to a corresponding one of the stored RGB color maps.

4. The inspection device of claim 3, wherein the controller is configured to perform the calibration by adjusting the light portion if the RGB color map of the calibration image does not match the corresponding one of the stored RGB color maps.

5. The inspection device of claim 3, further comprising a calibration selection portion configured to cause the controller to perform the calibration when the calibration selection portion is selected by the user.

6. The inspection device of claim 3, further comprising a display portion, wherein the display portion is configured to display images of the known fiber optic ribbon cables for selection by the user.

7. An inspection device configured to provide an enhanced inspection of a color order of colored fibers in a fiber optic ribbon cable, comprising:
an illumination portion configured to illuminate a fiber optic ribbon cable to be inspected;
an imaging portion configured to image an illuminated fiber optic ribbon cable to be inspected;
a memory portion configured to store image values for a selected fiber optic cable, wherein each of the selected fiber optic cables comprises fibers arranged in a known color order;
a controller configured to inspect a fiber optic ribbon cable;
wherein the controller is configured to control the imaging portion to generate an image of the fiber optic ribbon cable being inspected;
wherein the controller is configured to generate image values from the image of the inspected fiber optic ribbon cable;
wherein the controller is configured to compare the generated image values with the image values of the stored image values of the selected fiber optic ribbon cable; and
wherein the controller is configured to determine whether the fibers of the inspected fiber optic ribbon cable are arranged in a same color order as the fibers of the selected fiber optic ribbon cable so as to enhance accuracy of determining that the fibers of the inspected fiber optic ribbon cable are in a correct order before termination of the inspected fiber optic ribbon cable with a connector.

8. The inspection device of claim 7, wherein the inspection device is configured to output an indication of whether the fiber optic ribbon cable being inspected has the predetermined color order.

9. The inspection device of claim 7, wherein the image values from the image comprise a first RGB color map and the stored image values comprise a second RGB color map.

10. The inspection device of claim 7, wherein the inspection device is configured to output an indication of whether the fiber optic ribbon cable being inspected has a same fiber color order as the selected fiber optic ribbon cable.

11. The inspection device of claim 7, wherein the image values of the selected fiber optic ribbon cable comprise RGB values, and the controller is configured to perform a calibration by causing the imaging portion to create a calibration image of a fiber optic ribbon cable, creating an RGB color map of the calibration image, and comparing the RGB color map of the calibration image to a selected one of the RGB values of the selected fiber optic ribbon cable.

12. The inspection device of claim 11, wherein the controller is configured to perform the calibration by adjusting the light portion if the RGB color map of the calibration image does not match the corresponding one of the stored RGB color maps.

13. The inspection device of claim 11, further comprising a calibration selection portion configured to cause the controller to perform the calibration when the calibration selection portion is selected by a user.

14. The inspection device of claim 11, wherein the memory portion is configured to store image values for a plurality of known fiber optic cables;
wherein each of the known fiber optic cables comprises fibers arranged in a known color order; and
wherein the selected fiber optic cable is one of the known fiber optic cables.

15. The inspection device of claim 14, further comprising a display portion, wherein the display portion is configured to display images of the known fiber optic ribbon cables for selection by a user.

16. An inspection device configured to provide an enhanced inspection of a color order of colored fibers in a fiber optic ribbon cable, comprising:
an illumination portion configured to illuminate a fiber optic ribbon cable to be inspected;
an imaging portion configured to image an illuminated fiber optic ribbon cable to be inspected;
a controller configured to inspect a fiber optic ribbon cable;
wherein the controller is configured to control the imaging portion to generate an image of the fiber optic ribbon cable being inspected;
wherein the controller is configured to generate first image values from the image of the inspected fiber optic ribbon cable;
wherein the controller is configured to compare the first image values with stored second image values of a selected fiber optic ribbon cable comprising colored fibers arranged in a selected color order; and
wherein the controller is configured to determine whether the fibers of the inspected fiber optic ribbon cable are arranged in a same color order as the fibers of the selected fiber optic ribbon cable so as to enhance accuracy of determining that the fibers of the inspected fiber optic ribbon cable are in a correct order before termination of the inspected fiber optic ribbon cable with a connector.

17. The inspection device of claim 16, wherein the inspection device is configured to output an indication of whether the fiber optic ribbon cable being inspected has the predetermined color order.

18. The inspection device of claim 16, wherein the controller is configured to perform a calibration by causing the imaging portion to create a calibration image of a fiber optic ribbon cable, creating an RGB color map of the calibration image, and comparing the RGB color map of the calibration image to an RGB color map of the selected fiber optic ribbon cable.

19. The inspection device of claim 18, wherein the controller is configured to perform the calibration by adjusting the light portion if the RGB color map of the calibration image does not match the RGB color map of the selected fiber optic ribbon cable.

20. The inspection device of claim 18, further comprising a calibration selection portion configured to cause the controller to perform the calibration when the calibration selection portion is selected by a user.

21. The inspection device of claim 16, further comprising a memory portion configured to store the second image values for a plurality of known fiber optic cables;
wherein each of the known fiber optic cables comprises fibers arranged in a known color order; and
wherein the selected fiber optic cable is one of the known fiber optic cables.

22. The inspection device of claim 21, further comprising a display portion, wherein the display portion is configured to display images of the known fiber optic ribbon cables for selection by a user.

23. The inspection device of claim 16, wherein the first image values from the image comprise a first RGB color map and the stored second image values comprise a second RGB color map.

24. The inspection device of claim 16, wherein the inspection device is configured to output an indication of whether the fiber optic ribbon cable being inspected has a same fiber color order as the selected fiber optic ribbon cable.

25. The inspection device of claim 16, further comprising a memory portion configured to store the second image values.
